(19) United States
(12) Patent Application Publication
(10) Pub. No.: US 2011/0184098 A1
(43) Pub. Date: Jul. 28, 2011

(54) POLYACETAL RESIN COMPOSITION

(75) Inventors: Daisuke Sunaga, Mie (JP); Tsutomu Miyoshi, Mie (JP)

(73) Assignee: MITSUBISHI GAS CHEMICAL COMPANY, INC., Tokyo (JP)

(21) Appl. No.: 12/921,907

(22) PCT Filed: Mar. 10, 2009
(86) PCT No.: PCT/JP2009/054541

§ 371 Date: Apr. 14, 2011

(30) Foreign Application Priority Data
Mar. 11, 2008 (JP) 2008-61666

(51) Int. Cl. C08L 59/04; C08K 5/3492; C08K 5/20

(52) U.S. Cl. 524/101

(57) ABSTRACT

The object is to provide a polyacetal resin composition which is improved in the creep resistance, mold releasability and thermal resistance without impairing advantageous properties of polyacetal resins such as a high rigidity and an excellent moldability; and a method for producing the same. The present invention can provide a polyacetal resin composition, comprising 100 parts by weight of a (A) polyacetal resin, and the following (B) and (C) in the following amounts with respect thereto: 0.05 to 0.15 part by weight of an (B) amine-substituted triazine compound; and 0.10 to 0.20 part by weight of an (C) aliphatic compound.

### TECHNICAL FIELD

The present invention relates to a polyacetal resin composition comprising a polyacetal resin, an amine-substituted triazine compound and an aliphatic compound. Specifically, a preferable embodiment of the present invention relates to a polyacetal resin composition having an excellent creep resistance, a high mold releasability, and a good thermal stability exhibited when being kneaded or molded.

### BACKGROUND ART

Polyacetal resins are engineering plastic materials having a good balance of mechanical properties (friction/abrasion resistance, chemical resistance, creep resistance, size stability), a very high fatigue resistance and a low water absorbency. Owing to such characteristics, polyacetal resins are recently used for, for example, resin parts which are used for interior components of automobiles, interior components of houses and the like (heat/water mixing plugs, etc.), parts of clothing (fasteners, belt buckles, etc.), building materials (pipe and pump components, etc.) and electric components (gears, etc.), and so are increased in the demand.

However, as the uses thereof are widened, resin components having improved properties as materials are desired and are produced. For example, polyacetal resins are used for fuel components owing to an excellent chemical resistance thereof. However, when being always subjected to a constant pressure or always subjected to a stress by a pipe or the like, for example, when being used for fuel components, polyacetal resins have a serious problem of causing creep rupture in a short time even under a low stress. For this reason, a polyacetal resin composition which has a high toughness, especially a good creep resistance, and is produced at low cost has been strongly desired.

In response to such a desire, various polyacetal resin compositions have conventionally been studied in an attempt to improve the creep resistance thereof. For example, a polyacetal resin composition comprising a polyacetal resin, glass fiber, conductive carbon and a polyurethane-based resin has been proposed (see Patent Document 1).

Also, the following polyacetal resin composition, which is a mixture of polyoxymethylene copolymers as two components having different melt indices, has been proposed (see Patent Document 2). This polyacetal resin comprises 20 to 80% by weight of a high melt index component having a melt index of 300 or less, and the value obtained by dividing the melt index of the high melt index component by the melt index of a low melt index component is adjusted to 15. However, even these methods cannot sufficiently improve the creep resistance, mold releasability or thermal stability.
Patent Document 1: Japanese Laid-Open Patent Publication No. 11-1603
Patent Document 2: Japanese Laid-Open Patent Publication No. 2001-234025

### DISCLOSURE OF THE INVENTION

The present invention has an object of providing a polyacetal resin composition which solves the above-described problems and is significantly improved in the creep resistance, mold releasability and thermal resistance without impairing advantageous properties of polyacetal resins such as a high rigidity and an excellent moldability; and a method for producing the same.

As a result of accumulating active studies in order to solve the above-described problems, the present inventors found that at least one of the problems of the conventional art can be solved by a polyacetal resin composition comprising a polyacetal resin, a specific amount of amine-substituted triazine compound and a specific amount of aliphatic compound. The present inventors also found that a polyacetal resin composition in which a total amount of alkali metal and alkali earth metal is 50 ppm or less is excellent in the creep resistance, mold releasability and thermal stability. Thus, the present invention has been completed.

Namely, one embodiment of the present invention is directed to a polyacetal resin composition, comprising 100 parts by weight of a (A) polyacetal resin, and the following (B) and (C) in the following amounts with respect thereto.

0.05 to 0.15 part by weight of an (B) amine-substituted triazine compound; and

0.10 to 0.20 part by weight of an (C) aliphatic compound.

In the present invention, an embodiment in which the amine-substituted triazine compound is at least one selected from the group consisting of melamine, methylolmelamine, benzoguanamine and a water-soluble melamine-formaldehyde resin is preferable.

In the present invention, an embodiment in which the aliphatic compound is ethylenebisstearoamide is also preferable.

Another embodiment of the present invention is directed to a method for producing a polyacetal resin composition, comprising adding, to 100 parts by weight of a polyacetal resin, 0.05 to 0.15 part by weight of an (B) amine-substituted triazine compound and 0.10 to 0.20 part by weight of an (C) aliphatic compound; and heating and thus melting the resultant substance at a temperature in the range of 210 to 230° C. while deairing the resultant substance at a reduced pressure of 20.7 to 26.7 kPa.

In the present invention, an embodiment in which the deairing is performed at a reduced pressure of 21.3 kPa is preferable.

A polyacetal resin composition in a preferable embodiment of the present invention is significantly improved in the creep resistance, mold releasability and thermal stability. Owing to such excellent performances, the polyacetal resin composition is preferably usable for interior components of automobiles, interior components of houses and the like (heat/water mixing plugs, etc.), parts of clothing (fasteners, belt buckles, etc.), building materials (pipe and pump components, etc.), electric components (gears, etc.), fuel components, and the like.

### BEST MODE FOR CARRYING OUT THE INVENTION

Hereinafter, the present invention will be described in detail. The (A) polyacetal resin used for the present invention is a polymer having, as a repeat structure, acetal structure —(—O—CRH—)ₙ— (where R represents a hydrogen atom or an organic group); and usually has the repeat structure in which R is a hydrogen atom, namely, oxymethylene group (—CH₂O—), as a main structural unit. A polyacetal resin used for the present invention is not limited to an acetal homopolymer formed only of this repeat structure and may be a copolymer (for example, block copolymer), a terpolymer or the like further containing at least one type of repeat structural unit other than the oxymethylene group; and also may have a branched or crosslinked structure instead of a linear structure.

Examples of the structural unit other than the oxymethylene group include oxyalkylene groups which have a carbon number of 2 or greater and 10 or less and may be branched, such as oxyethylene group (—CH₂CH₂O—), oxypropylene group (—CH₂CH₂CH₂O—), oxybutylene group (—CH₂CH₂CH₂CH₂O—) and the like. Among these, oxyalkylene groups which have a carbon number of 2 or greater and 4 or less and may be branched are preferable, and oxyethylene group is especially preferable. The content of the oxyalkylene group used as the structural unit other than the oxymethylene group is, with respect to the polyacetal resin, preferably 0.1% by weight or greater and 20% by weight or less, and more preferably 0.5% by weight or greater and 15% by weight or less.

A method for producing the polyacetal resin is optional, and any conventionally known method is usable. For example, a polyacetal resin having, as a structural unit, an oxymethylene group and an oxyalkylene group having a carbon number of 2 or greater and 4 or less may be produced by copolymerizing the following: a cyclic oligomer of the oxymethylene group such as, for example, a trimer or a tetramer of formaldehyde (trioxane or tetraoxane), and a cyclic oligomer containing an oxyalkylene group having a carbon number of 2 or greater and 4 or less, such as ethylene oxide, 1,3-dioxorane, 1,3,6-trioxocane, 1,3-dioxepane or the like. The polyacetal resin used for the present invention is preferably a copolymer of a cyclic oligomer such as trioxane, tetraoxane or the like and ethylene oxide or 1,3-dioxorane; and more preferably a copolymer of trioxane and 1,3-dioxorane.

Specific examples of the (B) amine-substituted triazine compound include, for example, guanamine, melamine, methylolmelamine, N-butylmelamine, N-phenylmelamine, N,N-diphenylmelamine, N,N-diallylmelamine, N,N′,N″-triphenylmelamine, N,N′,N″-trimethylolmelamine, benzoguanamine, 2,4-diamino-6-methyl-sym-triazine, 2,4-diamino-6-butyl-sym-triazine, 2,4-diamino-6-benzyloxy-sym-triazine, 2,4-diamino-6-butoxy-sym-triazine, 2,4-diamino-6-cyclohexyl-sym-triazine, 2,4-diamino-6-chloro-sym-triazine, 2,4-diamino-6-mercapto-sym-triazine, ameline(N,N,N′,N′-tetracyanoethylbenzoguanamine), and an initial polycondensate of any one of these and formaldehyde.

Among these amine-substituted triazine compounds, melamine, methylolmelamine, benzoguanamine and a water-soluble melamine-formaldehyde resin are especially preferable.

The amount of the amine-substituted triazine compound to be incorporated is, with respect to 100 parts by weight of the polyacetal polymer, preferably 0.05 to 0.15 part by weight and more preferably 0.07 to 0.12 part by weight.

The (C) aliphatic compound used for the present invention is a compound having an aliphatic chain with no aromatic compound. The aliphatic chain may be straight, branched or cyclic. The aliphatic compound may be substituted with halogen atom, carboxyl group, alkylcarbonyl group, alkoxycarbonyl group, aminocarbonyl group, alkylaminocarbonyl group, hydroxyl group, alkoxy group, cyano group, nitro group, amino group, aminoalkyl group, sulfo group or the like. The aliphatic compound may contain two or more of the same or different substituents among the above in a molecule.

Preferable specific examples of the above include aliphatic hydrocarbon, fatty acid compounds, fatty acid amide compounds, and the like. Fatty acid amide compounds are more preferable.

Examples of the aliphatic hydrocarbon include fluid paraffin, montan wax, beewax, low-polymerized polyethylene, hydrogen-added polybutene and the like. Specific examples of the fatty acid compounds include straight-chain saturated fatty acid, cyclic saturated fatty acid, branched saturated fatty acid, unsaturated fatty acid, unsaturated fatty acid having a hydroxyl group, and the like.

Examples of the fatty acid amide compounds include compounds represented by RCONH₂, methylenebisamide compounds represented by RCHNH—CH₂—NHCOR, and ethylenebisamide compounds represented by RCONH—CH₂CH₂—NHCOR, which are respectively amide compounds obtained from a carboxylic compound represented by RCOOH and ammonia, methylenediamine and ethylenediamine. Examples of the carboxylic compound represented by RCOOH include straight-chain saturated fatty acid, cyclic saturated fatty acid, branched saturated fatty acid, unsaturated fatty acid, unsaturated fatty acid having a hydroxyl group, and the like. Specific examples of the fatty acid amide compounds include palmitylamide, stearyamide, oleylamide, methylenebisstearoamide, ethylenebisstearoamide, and the like. Ethylenebisstearoamide is more preferable.

The polyacetal resin composition according to the present invention comprises (A), (B) and (C) mentioned above as indispensable components, and may also include any of known additives and/or fillers in the range in which the object of the present invention is not spoiled. Examples of the additives include lubricant, antistatic agent, ultraviolet absorber, photostabilizer, coloring dye/pigment, and the like. Examples of the fillers include glass fibers, glass flakes, glass beads, talc, mica, calcium carbonate, potassium titanate whisker, and the like.

A method for producing the polyacetal resin composition according to the present invention is characterized in that, when the components (A) through (C) and other components used when necessary are mixed and kneaded, these components are heated to be melted at a temperature in the range of 210 to 230° C. while being deaired at a reduced pressure of 20.7 to 26.7 kPa. Especially preferably, the deairing is performed at a reduced pressure of 21.3 kPa.

Specifically, for example, to 100 parts by weight of the polyacetal resin, 0.05 to 0.15 part by weight of the (B) amine-substituted triazine compound and 0.10 to 0.20 part by weight of the (C) aliphatic compound are mixed at the same time or in an optional order. When necessary, other resin additives or the like are incorporated. Then, these components are mixed by a tumbler-type blender or the like. The obtained mixture is melted and kneaded and then extruded in the form of a strand by a monoaxial or a biaxial extruder. When being extruded, the mixture is heated to be melted at a temperature in the range of 210 to 230° C. while being deaired at a reduced pressure of 20.7 to 26.7 kPa (preferably at a reduced pressure of 21.3 kPa). Then, the mixture is pelletized. Thus, a polyacetal resin composition having a desired composition can be obtained.

The polyacetal resin composition according to the present invention can be molded in accordance with a known molding method of polyacetal resin. Molded items containing the polyacetal resin composition according to the present invention include various products which are known as being formed of a polyacetal resin, including materials such as pellets, round rods, thick boards and the like, sheets, tubes, various types of containers, various types of components of mechanical, electric, automobile, building and other parts, and the like.

### EXAMPLES

Hereinafter, the present invention will be described in more detail by way of examples, but the present invention may be carried out in examples other than the following specific examples without departing from the gist thereof.

### Examples 1 to 10; Comparative Examples 1 to 8

The (A) polyacetal resin, the (B) amine-substituted triazine compound and the (C) aliphatic compound of the amounts and the types shown in Tables 1 and 2 were mixed, heated to be melted at a temperature in the range of 210 to 230° C. while being deaired at a reduced pressure of 21.3 kPa, and then formed into pellets by a biaxial extruder. The obtained pellets were evaluated. In Tables 1 and 2, the “comonomer content” is the amount (parts by weight) of the comonomer (1,3-dioxorane) reacted with 100 parts by weight of trioxane. The amounts of the other additives are represented with the amounts (parts by weight) with respect to 100 parts by weight of the polyacetal resin obtained from trioxane and 1,3-dioxorane.

The creep resistance, fuel resistance, mold contamination, yellow discoloration, and thermal stability were evaluated as follows.

### (1) Creep Test

Using a creep tester produced by Toyo Seiki, a molded piece of 3 mm (D)×4 mm (W)×75 mm (L) was subjected to a stress of 20 MPa at 80° C. in the air, and the creep rupture time was measured.

### (2) Fuel Resistance

A dumbbell-type molded piece immersed in the following fuels at 65° C. for 2000 hours was subjected to a tensile test in accordance with ISO 527-1 and 2, and the fuel resistance was evaluated with the strength retaining ratio after the immersion with respect to the strength before the immersion.

Fuel (1): Toluene/isooctane=60 wt. %/40 wt. %

Fuel (2): Fuel (1)/ethanol=70 wt. %/30 wt. %

### (3) Mold Contamination, Yellow Discoloration

The mold contamination was evaluated with the amount of the contaminants adhering to the mold after 400 shots of molding were performed at a cylinder temperature of 200° C. and a mold temperature of 35° C., by stages 1 to 5 as follows.

Yellow discoloration was evaluated with the yellow discoloration degree of a piece molded at a cylinder temperature of 240° C. and a mold temperature of 80° C., by stages 1 to 5 as follows.

Expression 1

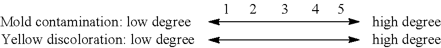

### (4) Thermal Stability

A molded piece was retained in a molding apparatus at a cylinder temperature at 240° C., and the time until foaming traces were exhibited on a surface of the molded piece was measured. The thermal stability was evaluated every 12 minutes, up to 72 minutes.

TABLE 1
Examples

| | | | | | | | Creep | | | | | |
|---|---|---|---|---|---|---|---|---|---|---|---|---|
| | | | | | | | rupture | | | | | |
| | | | | | | | time | Fuel resistance | | Mold | Yellow | Thermal |
| | Comonomer content | Mx | EBS | St-Ca | PEG | PW | (20 MPa) | Fuel(1) | Fuel(2) | contamination | discoloration | stability |
| | Parts by weight | Parts by weight | | | | | Hours | % | % | — | — | Minutes |
| 1 | 2.5 | 0.05 | 0.15 | | | | 1000 | 93 | 87 | 1 | 1 | 72 |
| 2 | 2.5 | 0.1 | 0.15 | | | | 1125 | 93 | 87 | 1 | 1 | 72 |
| 3 | 2.5 | 0.15 | 0.15 | | | | 975 | 92 | 86 | 1 | 1 | 72 |
| 4 | 2.5 | 0.1 | 0.2 | | | | 825 | 93 | 87 | 1 | 1 | 72 |
| 5 | 2.5 | 0.1 | 0.1 | | | | 1050 | 93 | 87 | 1 | 1 | 72 |
| 6 | 2.5 | 0.1 | 0.1 | 0.01 | | | 800 | 91 | 85 | 1 | 2 | 60 |
| 7 | 2.5 | 0.1 | 0.1 | | 0.1 | | 750 | 90 | 80 | 1 | 1 | 72 |
| 8 | 2.5 | 0.1 | 0.1 | | | 0.05 | 1050 | 91 | 84 | 2 | 1 | 72 |
| 9 | 2.0 | 0.1 | 0.15 | | | | 1200 | 95 | 89 | 1 | 1 | 72 |
| 10 | 3.0 | 0.1 | 0.15 | | | | 975 | 89 | 84 | 1 | 1 | 72 |

Comonomer: 1,3-dioxorane (comonomer for the (A) polyacetal resin)
Mx: Melamine ((B) amine-substituted triazine compound)
EBS: Ethylenebisstearoamide ((C) aliphatic compound)
St-Ca: Calcium stearate (additive)
PEG: Polyethyleneglycol 20000P (additive)
PW: Paraffin wax (additive)

TABLE 2
Comparative examples

| | | | | | | | Creep | | | | | |
|---|---|---|---|---|---|---|---|---|---|---|---|---|
| | | | | | | | rupture | | | | | |
| | | | | | | | time | Fuel resistance | | Mold | Yellow | Thermal |
| | Comonomer content | Mx | EBS | St-Ca | PEG | PW | (20 MPa) | Fuel(1) | Fuel(2) | contamination | discoloration | stability |
| | Parts by weight | Parts by weight | | | | | Hours | % | % | — | — | Minutes |
| 1 | 2.5 | 0.025 | 0.15 | | | | 625 | 93 | 87 | 1 | 1 | 60 |
| 2 | 2.5 | 0.25 | 0.15 | | | | 650 | 91 | 85 | 2 | 1 | 36 |
| 3 | 2.5 | 0.1 | 0.25 | | | | 625 | 92 | 86 | 3 | 1 | 72 |
| 4 | 2.5 | 0.1 | | 0.15 | | | 750 | 89 | 83 | 4 | 4 | 36 |
| 5 | 2.5 | 0.1 | | | 0.15 | | 700 | 90 | 76 | 2 | 1 | 72 |
| 6 | 2.5 | 0.1 | | | | 0.15 | 900 | 90 | 83 | 5 | 1 | 72 |

Comonomer: 1,3-dioxorane (comonomer for the (A) polyacetal resin)
Mx: Melamine ((B) amine-substituted triazine compound)
EBS: Ethylenebisstearoamide ((C) aliphatic compound)
St-Ca: Calcium stearate (additive)
PEG: Polyethyleneglycol 20000P (additive)
PW: Paraffin wax (additive)

### INDUSTRIAL APPLICABILITY

The polyacetal resin composition according to the present invention is preferably usable for, for example, interior components of automobiles, interior components of houses and the like (heat/water mixing plugs, etc.), parts of clothing (fasteners, belt buckles, etc.), building materials (pipe and pump components, etc.), electric components (gears, etc.), fuel components, and the like.

1. A polyacetal resin composition, comprising:
100 parts by weight of a (A) polyacetal resin, and the following (B) and (C) in the following amounts with respect thereto:
0.05 to 0.15 part by weight of an (B) amine-substituted triazine compound; and
0.10 to 0.20 part by weight of an (C) aliphatic compound.

2. The polyacetal resin composition according to claim 1, wherein the amine-substituted triazine compound is at least one selected from the group consisting of melamine, methylolmelamine, benzoguanamine and a water-soluble melamine-formaldehyde resin.

3. The polyacetal resin composition according to claim 1, wherein the aliphatic compound is ethylenebisstearoamide.

4. A method for producing a polyacetal resin composition, comprising adding, to 100 parts by weight of a polyacetal resin, 0.05 to 0.15 part by weight of an (B) amine-substituted triazine compound and 0.10 to 0.20 part by weight of an (C) aliphatic compound; and heating and thus melting the resultant substance at a temperature in the range of 210 to 230° C. while deairing the resultant substance at a reduced pressure of 20.7 to 26.7 kPa.

5. The method for producing a polyacetal resin composition according to claim 4, wherein the deairing is performed at a reduced pressure of 21.3 kPa.

6. The method for producing a polyacetal resin composition according to claim 4, wherein the amine-substituted triazine compound is at least one selected from the group consisting of melamine, methylolmelamine, benzoguanamine and a water-soluble melamine-formaldehyde resin.

7. The method for producing a polyacetal resin composition according to claim 4, wherein the aliphatic compound is ethylenebisstearoamide.
